(19) United States
(12) Patent Application Publication
(10) Pub. No.: US 2008/0236514 A1
(43) Pub. Date: Oct. 2, 2008

(54) Training Device and a Method For Training an Animal to Adapt Its Behavior to Various Environments

(75) Inventors: Mark Thomas Johnson, Eindhoven (NL); Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,858

(22) PCT Filed: Aug. 14, 2006
(86) PCT No.: PCT/IB06/52801

§ 371 Date: Feb. 15, 2008

(30) Foreign Application Priority Data
Aug. 19, 2005 (EP) 05107619.8

(51) Int. Cl. A01K 15/00; A01K 15/02; A01K 15/04

(52) U.S. Cl. 119/719; 119/720; 340/573.3

(57) ABSTRACT

This invention relates to a training device (10) to be attached to or be worn by an animal (103) for training the animal to adapt its behavior to various environments (105-108), where the training device is operated by a trainer (102) of the animal. The training involves selecting various training setups, which are adapted to the various environments. A receiving means is used for receiving an input from the trainer, or from a training setup device used by the trainer, for initiating a new training setup. A detecting means is used for detecting parameters relating to the animal, wherein the parameters are regularly compared to the training setup. An output means is used for influencing the behavior of the animal if one or more of the detected parameters contradict with the training setup.

### FIELD OF THE INVENTION

The present invention relates to a training device and a method for training an animal to adapt its behavior to various environments, said training device being operated based on various training setups, which are adapted to the various environments, and are selected by the trainer of said animal. The present invention further relates to a training setup device used by a trainer of said animal for selecting various training setups when training the animal to adapt its behavior to various environments.

### BACKGROUND OF THE INVENTION

Owners of animals (pets, circus/zoo animals, livestock) are prepared to spend much time and money (i.e. courses, books etc.) on training their animals. They would therefore be greatly interested in an (electronic) aid to improve the training of their animal.

In addition, when an animal is trained (or indeed during the training), there will be periods of time where the animal will be allowed significantly more freedom of action than in other situations. It is therefore of great importance that the training of the animals involves teaching the animals to adapt their behavior to the environment the animals are in, since the animals may not always realize their “status”. As an example, a dog in a country environment may have more freedom to run and bark than a dog in a busy city street environment, whilst a guard dog will not always be “on duty”.

In U.S. Pat. No. 5,857,433 a device is disclosed for training/controlling an animal. The device includes both an aversive stimuli unit and a global positioning satellite system unit in housing. Coupled to the housing is a harness, collar or other mechanism for attaching the device to an animal. The aversive stimuli unit is remotely operable using a hand-held control unit to aversively stimulate the animal wearing the housing. The global positioning satellite unit coupled to the housing allows determination of the animal's position relative to the operator of the hand-held control unit. A preferred embodiment of the invention is designed particularly for tracking and training or controlling one or more dogs.

The type of training as disclosed in U.S. Pat. No. 5,857,433 does, however, not include training the animals to adapt their behavior to the various environments the animals are in.

### OBJECT AND SUMMARY OF THE INVENTION

It is an object of the present invention to provide a device and a method for training the animals to adapt their behavior to the various environments the animals are in.

According to one aspect, the present invention relates to a training device to be attached to or to be worn by an animal for training the animal to adapt its behavior to various environments, said training device being operated based on various training setups, which are adapted to said various environments and are selected by the trainer of said animal, said device comprising:

means for receiving an input from said trainer, or from a training setup device operated by said trainer, for a new training setup to be initiated,

a processor for processing said received input,

detecting means for detecting at least one parameter relating to said animal, wherein said at least one parameter is regularly compared to said training setup, and

output means for influencing the behavior of the animal, if one or more of said detected parameters contradict with said training setup.

In that way, the animal can be taught in a very effective way how to behave in different environments. A dog, as an example, can therefore learn how to adapt its behavior depending one whether the dog is in a country environment or in a busy city street environment. In the former case, the dog may e.g. be allowed to bark with an unlimited frequency, whereas in the latter case the barking frequency may be very low. The dog/animal will therefore be taught to be aware of its “status”. Furthermore, the same training device can be used for training different animals, simply by adjusting the training setups to said animals. Said training setups may e.g. comprise a training setup with no limitations or rules, e.g. a “free training setup”, and a training setup with limitations, which the animal is to follow. As an example, a training setup training a dog to become a guard dog is adjusted to a “free training setup” when the dog is not on “duty”. The training device may of course also be turned off when said dog is not on “duty”.

In an embodiment, said training device further comprises a memory for storing said new training setup, or having said training setups pre-stored. The memory can therefore be used to store a received training setup sent by the training setup device operated by said user, or for initiation one of said pre-stored training setups.

In an embodiment, said processor performs said regular comparison between the at least one parameter and said training setup, said processor further being adapted to operate said output means. This makes the training device more intelligent and almost, or completely, independent of external processing.

In an embodiment, said means for receiving said input from said trainer comprises a receiver adapted to receive transmitted training setups from said training setup device used by the trainer, or for receiving a request from said trainer to initiate a new training setup. The trainer can accordingly select training setups from said training setup device, which makes the operation of the training device very user friendly. As an example, if the trainer notices that his/her animal is outside playing in the garden, the trainer can remotely adjust the training setup from e.g. “in-house training setup” to “outside training setup”, where the animal has more freedom. Also, the trainer can send said request for initiating a new training setup from e.g. selecting from a display of said training setup device, which training setup is to be initiated. The same training setup is preferably also associated to the time of day, i.e. the time of the day is parameters, which may automatically adjust the training setup. As an example, the allowed barking frequency of a dog depends on whether the dog is outside in the garden at 6 a.m. or at 6 p.m.

In one embodiment, said means for receiving said input from said trainer comprises a push or a touch button function for selecting said new training setup, or a speech recognizer for recognizing speech commands from said trainer. In that way, the trainer can adjust the training directly on the animal, e.g. via pressing buttons or use an oral command indicating said new training setup.

In an embodiment, said input from said trainer comprises a request for initiating said new training setup, which is pre-stored at said memory. It is therefore sufficient to receive an input from the trainer comprising a request to initiate a new training setup from said pre-stored training setups.

In an embodiment, said input from said trainer comprises said new training setup, which is wirelessly transmitted by said training setup device operated by said trainer, wherein said training setup is subsequently stored at said memory. The memory does therefore not need to have all said training setups pre-stored. Instead, each time the trainer selects a new training setup using said training setup device it is transmitted to the training device worn by the animal where it replaces the previous stored training setup.

In an embodiment, said training setups comprise one or more training rules defining boundary values for the animal to follow during said training. An example of a training rule to be used is the barking frequency, forbidden zones e.g. the position of the living room where the animal is not allowed to enter, blood pressure or maximum production of any kind of chemical elements produced in the animal. In that way, it may be prevented that e.g. a dog becomes too excited. This could otherwise e.g. result in that the dog attacks other animals or human beings.

In an embodiment, said at least a part of said training device is implanted within the body of the animal.

In an embodiment, said detecting means for detecting said at least one parameter relating to said animal comprises at least one detecting means from a group consisting of:

a Global Positioning System (GPS),

an electronic fence device using GPS and two-way communications technology,

a receiver for receiving RF signals produced by a transmitter, said transmitter being used as the center of the “Virtual Fence” area,

electrocardiogram,

electroencephalogram,

accelerometer,

3D-compass,

a temperature sensor,

a blood sensor, and

a nerve sensor.

These sensors could e.g. be attached to the neckband worn by the animal, or be integrated into the animal (in the case of nerve and blood sensors).

In an embodiment, said output means comprise at least one output source from a group consisting of:

a light source,

a speaker for generating an acoustic signal,

an electrical or mechanical signal,

a heat or pressure signal, and

(narcotic) drug delivery.

Accordingly, the animal can be notified if the boundary values comprised in said training setups are violated, e.g. the animal is located in a forbidden zone. For example, the light source could first be used to indicate that one or more of said boundary values in the running training setup has/have been violated, e.g. by blinking a red light. If the animal does, however, not respond to that, the speaker could be used to generate an acoustic signal at e.g. high frequency larger than 20 kHz. In that way the output means can be operated stepwise in one or more steps.

In an embodiment, said training device further comprises a transmitter for transmitting said at least one parameter relating to said animal to said training setup device operated by said trainer. This is the case where the training device is operated from the training setup device used by the trainer, wherein the processing of regularly comparing said at least one parameter with the training setup is performed at the training setup device.

According to another aspect, the present invention relates to a method of training an animal to adapt its behavior to various environments, said method comprising using a training device to be attached to or to be worn by the animal, said training device being operated based on various training setups, which are adapted to said various environments and are selected by the trainer of said animal, said method comprising the steps of:

receiving an input from said trainer, or from a training setup device operated by said trainer, for a new training setup to be initiated,

processing said received input,

detecting at least one parameter relating to said animal, wherein said at least one parameter is regularly compared to said training setup, and

influencing the behavior of the animal if one or more of said detected parameters contradict with said training setup.

In one embodiment, the step of influencing the behavior of the animal comprises using sequential painful sanctions until the behavior of said animal has been influenced. In another embodiment, said sequential painful sanctions comprise increasingly painful sanctions. This is necessary when the animal does not respond to the first “warning” from the trainer of the animal, and since the physiological condition of the animals can be very different, whereby the effect resulting from said painful sanctions can be very different. In that way, it is ensured that the animal will in the end always be influenced. Increasingly painful sanctions may comprise adjusting the amplitude/magnitude level (in case of electrical or acoustic signal) or different sanctions.

In an embodiment, said method further comprises giving positive response, such as praise or encouragement, if said parameters do not contradict with said training setup. In that way, the animal also receives a positive feedback from the trainer.

According to yet another aspect, the present invention relates to a training setup device operated by a trainer of an animal for selecting various training setups when training the animal to adapt its behavior to various environments, wherein the selected training setups are transmitted to a training device attached to or worn by the animal, which is operated based on said training setups, said training setup device comprising:

an input means for receiving an input from said trainer for a new training setup to be initiated,

a processor for processing a received input from said trainer of the animal when selecting a new training setup, and

a transmitter for transmitting the result of said processing to said training device.

Thereby, the trainer of the animal can in a very user friendly way select a new training setup when the environment the animal is in changes. This can be the case where e.g. the trainer (e.g. the owner of an animal) lives on the countryside where strict “in-house” rules are being used e.g. relating to barking if the animal is a dog, whereas outside the house the animal has much more freedom, e.g. the dog is allowed to bark with unlimited frequency. The trainer can therefore remotely adjust the training program when he/she sees that the dog is outside. The training setup device may further be adapted to automatically detect, via e.g. GPS or local environmental sensors, that the dog is outside and based thereon automatically shift to the correct training setup.

In an embodiment, said training setup device further comprises a memory for storing said training setups, wherein processing said received input from said trainer comprises extracting training rules comprised in the new training setup from said memory.

In an embodiment, said training setup device further comprises a receiver for receiving information from said training device worn by the animal. This could e.g. be the case where the process of comparing the parameters (detected by said detecting means at the training device) related to the animal to the running training setup is performed by the processor at the training setup device. In this case, said parameters must regularly be transmitted from the training device to the training setup device. The training device worn by the animal may therefore mainly be adapted to regularly or continuously transmit said behavior data to the training setup device, which then performs the main processing steps.

According to yet another aspect, the present invention relates to a method of training an animal to adapt its behavior to various environments, said training comprising using a training setup device operated by a trainer of an animal for selecting various training setups when training the animal to adapt its behavior to various environments, wherein the selected training setups are transmitted to a training device attached to or worn by the animal and which is operated based on the training setups, the method comprising the steps of:

receiving an input from said trainer for a new training setup to be initiated,

processing a received input from said trainer of the animal, and

transmitting the result of said processing to said training device.

In a further aspect, the present invention relates to a computer readable medium having stored therein instructions for causing a processing unit to execute said methods.

These and other aspects of the invention will be apparent from and elucidated with reference to the embodiment(s) described hereinafter.

### BRIEF DESCRIPTION OF THE DRAWINGS

In the following preferred embodiments of the invention will be described referring to the figures, where

FIG. 1 illustrates the principle of the present invention, namely to train an animal to adapt its behavior to various environments,

FIG. 2 shows one embodiment of a training setup device according to the present invention,

FIG. 3 shows one embodiment of a training device according to the present invention,

FIG. 4 illustrates a method according to the present invention for selecting a training setup for an animal based on the training environments, and

FIG. 5 illustrates a method according to the present invention for selecting a training setup for an animal based on the training environments or the “status” the animal is in.

### DESCRIPTION OF PREFERRED EMBODIMENTS

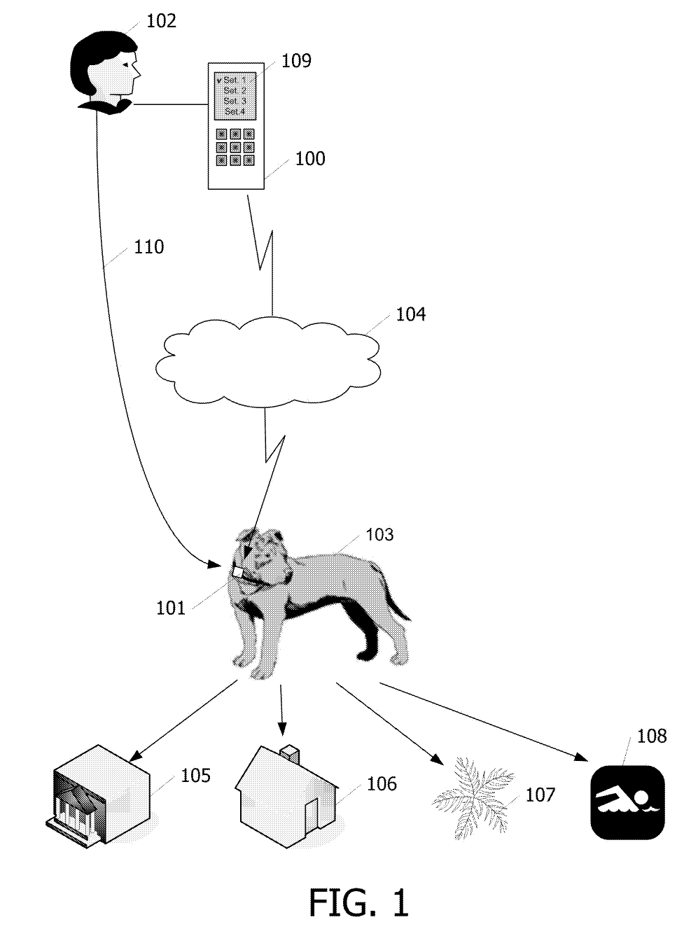

FIG. 1 illustrates the principle of the present invention, namely to train an animal to adapt its behavior to various environments, wherein the training is based on using various training setups, which are selected by the trainer of the animal, and are adapted to the various environments the animal is in. The training setups comprise one or more training rules, which define boundary values for the animal to follow during the training. In the present invention the animal is taught to learn how to adapt its behavior to the environment the animal is in. In the following, it will be assumed that the animal is a dog. This training setup could of course be used for all kinds of animals and animal races.

FIG. 1 shows the trainer 102 (which can be the owner of the dog or any person) of a dog 103 using a training setup device 100 for selecting the training setup for the dog 103. This training setup can e.g. be selected by pressing a push button or touch button on the training setup device 100 or selection via a touch screen. The training device 101, which is e.g. attached to the dog 103 via a neckband, is adapted to receive the input from the owner 102 and based thereon initiate a new training setup.

In an embodiment, at least a part of said training device 101, e.g. one or more sensors, are implanted within the body of the animal.

In one embodiment the training setup device 100 is integrated in a “normal” mobile phone, with additional software running on it. Moreover, the training setup device 100 might be linked to a central server/database allowing/obtaining advice/applying new advanced training methods and/or possibilities of updates (like interpretation of measurement data/thresholds etc.).

In one embodiment, the training setup is initiated at the training setup device 100 by extracting the training rules, which are associated to the selected training setup, and subsequently transmitting the training rules over a wireless communication channel 104 to the training device 101 where they are stored and used as the new training setup.

In another embodiment, the training setup is initiated at the training device 101, where a request from the owner for a new training setup is transmitted over the communication channel 104 to the training device 101, wherein the request is processed, and based thereon a new training setup is initiated. In this embodiment, said various training setups are stored at the training device 101.

In an embodiment, the trainer 102 can interact directly 110 with the training device 101 worn by the dog 103 when selecting the training setup, e.g. via a push or a touch button function comprised in the training device 101, or via a speech recognizer for recognizing speech commands from said trainer. In that way, the trainer can adjust the training directly on the animal, e.g. via pressing buttons or use an oral command indicating said new training setup.

The training rules can e.g. comprise a coordinate position of forbidden zones, which could be the living room or the bathroom, and distance boundaries defining the maximum distance the dog 103 is allowed to go alone. The training device 101 would accordingly comprise a GPS system to give the current coordinate position of the dog, which position is then being processed and compared to the coordinate position of the forbidden zones. If the comparison indicates that the current coordinate position is within a forbidden zone, the dog is notified.

Another example of a training rule which could be used is the barking frequency of the dog 103, e.g. the number of times the dog 103 is allowed to bark every minute. The barking could be detected by a microphone attached to the training device, wherein the number of times the dog 103 barks, e.g. every 60 seconds, is registered and compared to the set of rules relating to the barking frequency. Again, the dog is notified if the barking frequency is too high.

Other examples of training rules are the maximum blood pressure or maximum production of any kind of chemical elements produced in the animal, where appropriate sensors could be attached to the training device 101, or be integrated into the animal. In that way, it may be prevented that e.g. the dog 103 becomes too excited. This could otherwise e.g. result that the dog 103 attacks other animals or human beings.

In the embodiment shown in FIG. 1, the owner 102 can select between four different training setups, which may be displayed on a display 109 on the remote control. One of the training setups is adapted for environment comprising a crowd of people, e.g. in an official building 105 or any kind of official places, one is adapted for the home 106 of the dog, one is adapted for the wood or the country side 107, and one is adapted for the lake 108 where the dog is e.g. allowed to swim. These different environments call for different training setups, which aim at teaching the dog 103 to adapt its behavior to these different environments. I.e. in the wood 107 the training setup is very flexible and the dog can run freely and bark, whereas in the official building 105 the training setup is very strict since the dog is e.g. supposed to be very quiet and walk next to the owner 102 the whole time the training setup for official building 105 is running. The number of training setups can of course be more or less than four. This can e.g. depend on the race of the dog, the type of animal etc. or based on the needs of the owner/trainer of the dog 103.

In an embodiment, the trainer 102 can initially obtain said training setups from e.g. the Internet by e.g. downloading different training setups directly to the training setup device 100 or to the training device 101 worn by the dog 103. The trainer 102 may also be able to purchase various training setups on e.g. a CD disc or at the Internet. In that way the trainer 102 can customize the training of the dog 103 to the environment the dog 103 is usually in.

As mentioned previously, the dog 103 is notified if the set of rules is not followed. This is done using output means comprised in the training device 101 which notify the dog 103 when the one or more training rules are violated. In one embodiment, at least two levels of interventions are used. E.g. when the barking frequency exceeds the setup rule defining the barking frequency, the dog 103 is notified by a visible light. If, however, the dog continues the barking a painful stimuli such as an acoustic signal at high frequency and large amplitude is provided. Accordingly, the aim is to use the self-learning ability of the animal, i.e. in this case the dog 103, so that he will learn that he can prevent himself from being hurt by the sound if he reacts already on the light according to the rules. In that way, the animal can be trained very effectively where it adapts its behavior to various environments/conditions. Such interventions with an increasing level of painful stimuli are preferably used for notifying the dog 103.

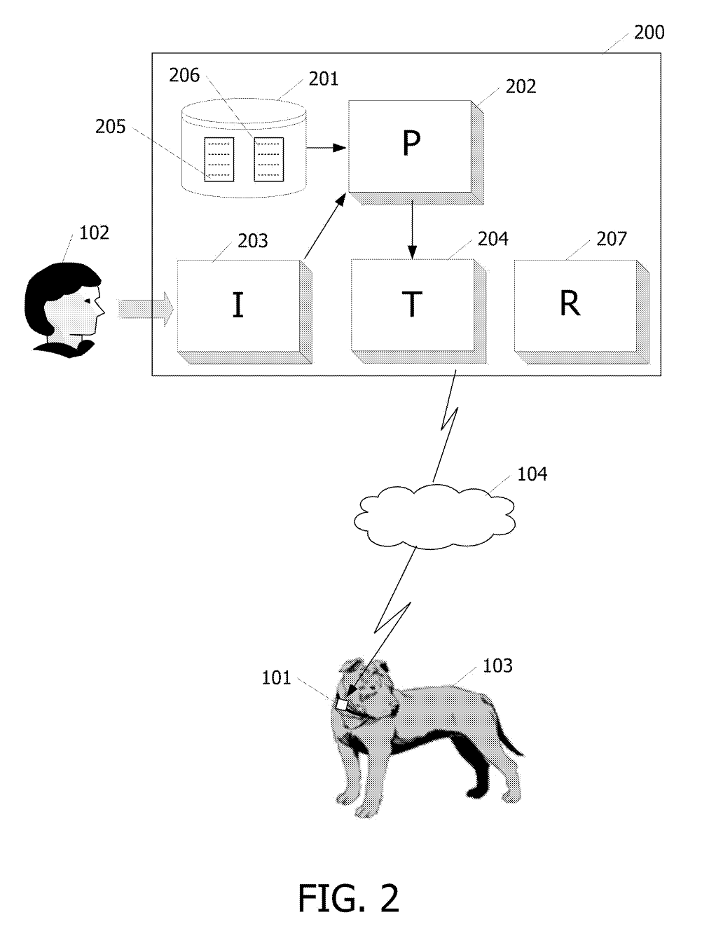

FIG. 2 shows one embodiment of a training setup device 100, 200 according to the present invention, comprising an input means (I) 203 for receiving input from said owner 102, a processor (P) 202 for processing the input and a transmitter (T) 204 for transmitting the result of the processing over said wireless communication channel 104 to said training device 101 which is worn by the dog 103 (or any kind of animal). The result of the processing can comprise extracting training rules associated to the selected training setup, or to convert the received input into a request for initiating a specific training program. The input means (I) can e.g. comprise a push or touch button function where the owner can select the training setup program or a speech recognizer so that the owner 102 can communicate orally with the training setup device 100, 200.

In a preferred embodiment, the training setup device 100, 200 further comprises a memory 201 having stored therein various training setups, wherein each training setup is defined by a set of rules 205, 206, as discussed previously in FIG. 1. In this embodiment, the rules comprised in the selected training setup are extracted from the memory 201 and transmitted by said transmitter (T) 204 to the training device 101, where they are stored. If the owner 102 then selects a new training setup, a new training setup with new set of rules 205, 206 is transmitted to the training device 101 where it replaces the previous training setup.

In a preferred embodiment, said training setup device 100, 200 further comprises a receiver (R) 207 for receiving information from said training device 101 attached or worn by the animal.

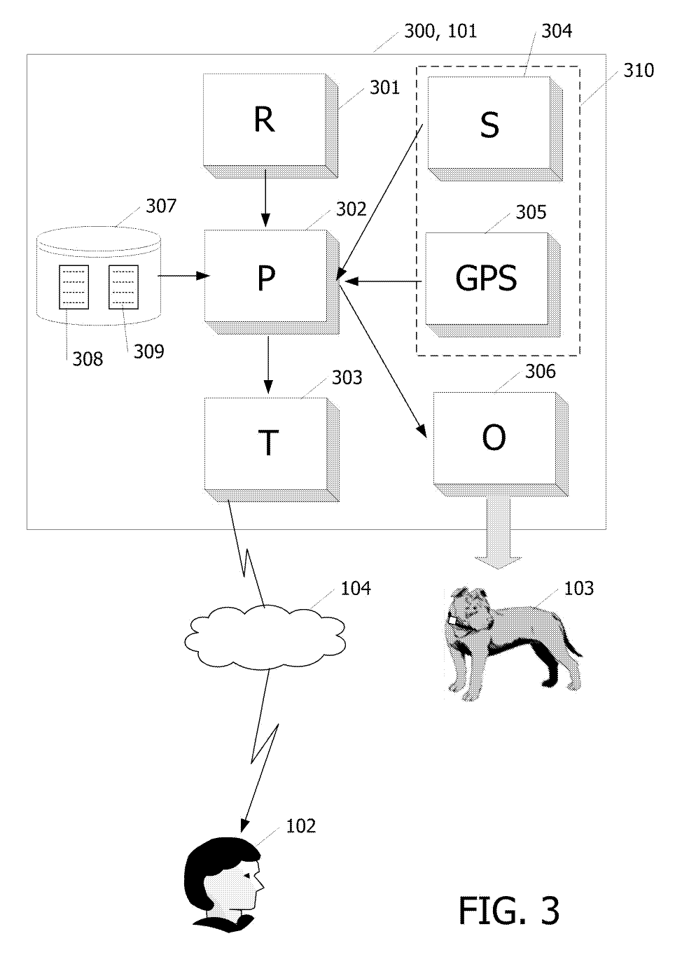

FIG. 3 shows one embodiment of a training device 300, 101 according to the present invention comprising a receiver (R) 301, a processor (P) 302, a memory 307, a transmitter (T) 303, a detecting means 110 comprising at least one sensor (S) 304 and a GPS system (GPS) 305, and an output means (O) 306 for influencing the behavior of the dog 103 (animal). The receiver (R) 301 is adapted to receive said input from the owner 102 indicating the setup program to be used, or to receive said transmitted training rules 205, 206, which are then stored in memory 307. The memory 307 can further be adapted to store a number of various training setups and the associated training rules 308, 309, wherein, based on the received input from the owner 102, the processor (P) 302 activates one of the pre-stored training setups.

The output means (O) 306, which is operated by the processor (P) 302, comprises, in one embodiment, a light source, for instance a visible light source, or a speaker for generating an acoustic signal at e.g. high frequency larger than 20 kHz. The output means (O) 306 can also comprise means for providing an electrical or mechanical signal, drug delivery etc. An additional feature to be used in the training device 300, 101 is a feedback feature (not shown) for rewarding the dog 103 for desired behavior. This could e.g. be a recorded praise from the owner 102, a physical reward, or to allow the dog 103 more freedom of operation.

The GPS system 305 gives the current position of the dog 103, which can be used when comparing the position with the coordinate position of forbidden zones, i.e. to determine whether the dog 103 is within the boundaries defined in the set of rules within the running setup program. This is regularly checked by the processor (P) 302, wherein the processor activates the output means (O) 306 when the current position of dog 103 is outside said boundaries.

Also, electronic fence devices using GPS and two-way communication technology could be implemented for monitoring whether or not the dog 103 is within a given radius, wherein the training rule relating to distance boundaries is one or more maximum radius values of the electronic fence. Therefore, if the dog 103 wanders outside the fence, the output means will be activated for notifying the dog 103.

In cases where the reception of GPS signals is difficult or impossible, e.g. inside buildings, a small local transmitter that produces an RF signal can be situated and used as the center of the “Virtual Fence” area. A light weight receiver worn by the dog 103 will sound a warning when the received RF signal becomes too weak. Should the dog 103 remain close to the boundary, the output means can be activated.

The sensor (S) 304 can comprise a number of sensors for measuring the physical state of the dog 103, e.g. ECG/EEG signal measured in a contact less manner, temperature sensor, blood sensors, sensors attached to the nerves etc. The resulting output signals are received by the processor (P) 302, which compares the values with the training rules in the running setup program. Again, if the received output signals are outside the boundaries as defined in the training rules, e.g. the output signal(s) is too high, the processor (P) 302 activates the output means (O) 306.

In an alternative embodiment, the sensor (S) 304 is a separate device, communicating with the training device 300, 101 or the training setup device 100, 200. In this case, the sensor (S) 304 could also be an implantable device, designed to be positioned within the body of the animal.

The transmitter (T) 303 is necessary when the setup program is running from the training setup device 200, wherein the transmitter (T) 303 transmits all said data, i.e. the GPS coordinates and the output signals from said sensor(s) (S) 304 to the training setup device 200. There they are processed and compared to the running training setup, wherein the activation of the output means (O) 306 is operated by the processor (P) 202 at the training setup device 200.

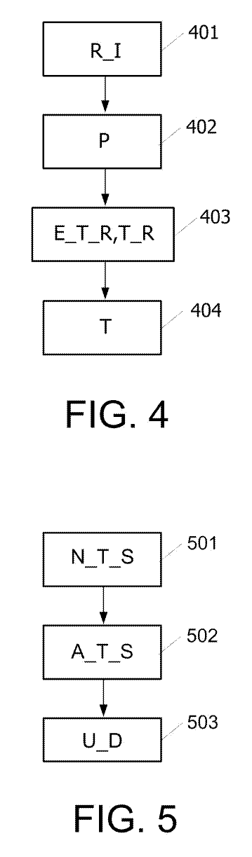

FIG. 4 illustrates a method according to the present invention for selecting a training setup for an animal based on the training environments. Initially an input request is received (R_I) 401 from an owner or a trainer of the animal for selecting a new training program for the animal. This input is processed (P) 402 and used for either extracting pre-stored training rules (B_T_R) 403, or for generating a training setup request (T_R) 403. The result of the processing is then transmitted (T) 404 to the training device worn by the animal.

FIG. 5 illustrates a method according to the present invention for selecting a training setup for an animal based on the training environments or the “status” the animal is in, wherein either said input from an owner of the animal is received requesting for a new training setup, or said set of training rules are received corresponding to a new training setup (N_T_S) 501. In the former case, the received input is processed and used for activating a new training setup (A_T_S) 502, and thereby updating (U_D) 503 or re-defining the current training setup. In the latter case the received set of rules corresponding to said new training setup (N_T_S) 501 is stored and used for activating a new training setup (A_T_S) 502 and thereby updating (U_D) 503 or re-defining the current training setup.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A training device to be attached to or to be worn by an animal for training the animal to adapt its behavior to various environments, said training device being operated based on various training setups, which are adapted to said various environments and are selected by the trainer of said animal, said device comprising:
means for receiving an input from said trainer, or from a training setup device used by said trainer, for a new training setup to be initiated,
a processor for processing said received input,
detecting means for detecting at least one parameter relating to said animal, wherein said at least one parameter is regularly compared to said training setup, and
output means for influencing the behavior of the animal if one or more of said detected parameters contradict with said training setup.

2. The training device according to claim 1, further comprising a memory for storing said new training setup, or having said training setups pre-stored.

3. The training device according to claim 1, wherein said processor performs said regular comparison between the at least one parameter and said training setup, said processor further being adapted to operate said output means.

4. The training device according to claim 1, wherein said means for receiving said input from said trainer comprises a receiver adapted to receive transmitted training setups from said training setup device used by the trainer, or for receiving a request from said trainer to initiate a new training setup.

5. The training device according to claim 1, wherein said means for receiving said input from said trainer comprises a push or a touch button function for selecting said new training setup, or a speech recognizer for recognizing speech commands from said trainer.

6. The training device according to claim 1, wherein said input from said trainer comprises a request for initiating said new training setup, which is pre-stored at said memory.

7. The training device according to claim 1, wherein said input from said trainer comprises said new training setup, which is wirelessly transmitted by said training setup device operated by said trainer, wherein said training setup is subsequently stored at said memory.

8. The training device according to claim 1, wherein said training setups comprise one or more training rules defining boundary values for the animal to follow during said training.

9. The training device according to claim 1, wherein at least a part of said training device is implanted within the body of the animal.

10. The training device according to claim 1, wherein said detecting means for detecting said at least one parameter relating to said animal comprises at least one detecting means selected from a group consisting of:
a Global Positioning System (GPS),
an electronic fence device using GPS and two-way communications technology,
a receiver for receiving RF signals produced by a transmitter, said transmitter being used as the center of the “Virtual Fence” area,
an electrocardiogram,
an electroencephalogram,
an accelerometer,
a 3D-compass,
a temperature sensor,
a blood sensor, and
a nerve sensor.

11. The training device according to claim 1, wherein said output means comprises at least one output source selected from a group consisting of:
a light source,
a speaker for generating an acoustic signal,
an electrical or mechanical signal,
a heat or pressure signal, and
(narcotic) drug delivery.

12. The training device according to claim 1, further comprising a transmitter for transmitting said at least one parameter relating to said animal to said training setup device operated by said trainer.

13. A method of training an animal to adapt its behavior to various environments, said method comprising:
using a training device to be attached to or to be worn by the animal, said training device being operated based on various training setups, which are adapted to said various environments and are selected by the trainer of said animal;
receiving an input from said trainer or from a training setup device operated by said trainer for a new training setup to be initiated,
processing said received input,
detecting at least one parameter relating to said animal, wherein said at least one parameter is regularly compared to said training setup, and
influencing the behavior of the animal if one or more of said detected parameters contradict with said training setup.

14. The method according to claim 13, wherein the influencing comprises using sequential painful sanctions until the behavior of said animal has been influenced.

15. The method according to claim 14, wherein said sequential painful sanctions comprise increasingly painful sanctions.

16. The method according to claim 13, further comprising giving positive response if said parameters do not contradict with said training setup.

17. (canceled)

18. A training setup device operated by a trainer of an animal for selecting various training setups when training the animal to adapt its behavior to various environments, wherein the selected training setups are transmitted to a training device attached to or worn by the animal and which is operated based on the training setups, said training setup device comprising:
an input means for receiving an input from said trainer for a new training setup to be initiated,
a processor for processing a received input from said trainer of the animal when selecting a new training setup, and
a transmitter for transmitting the result of said processing to said training device.

19. The training setup device according to claim 18, further comprising a memory for storing said training setups, wherein processing said received input from said trainer comprises extracting training rules comprised in the new training setup from said memory.

20. The training setup device according to claim 18, further comprising a receiver for receiving information from said training device attached to or worn by the animal.

21. A method of training an animal to adapt its behavior to various environments, said training comprising using a training setup device operated by a trainer of the animal for selecting various training setups when training the animal to adapt its behavior to said various environments, wherein the selected training setups are transmitted to a training device attached to or worn by the animal and which is operated based on the training setups, the method comprising:
receiving an input from said trainer for a new training setup to be initiated,
processing the received input from said trainer, and
transmitting the result of said processing to said training device.

22. (canceled)
